(19) United States
(12) Patent Application Publication
(10) Pub. No.: US 2014/0300614 A1
(43) Pub. Date: Oct. 9, 2014

(54) PROGRAMMABLE PREDICTION LOGIC IN COMMAND STREAMER INSTRUCTION EXECUTION

(71) Applicant: INTEL CORPORATION, Santa Clara, CA (US)

(72) Inventors: Hema C. Nalluri, Andhara Pradesh (IN); Peter L. Doyle, El Dorado Hills, CA (US); Jeffrey S. Boles, Folsom, CA (US); Joy Chandra, Kundanahalli Bangalore (IN)

(21) Appl. No.: 14/128,536

(22) PCT Filed: Dec. 18, 2012
(86) PCT No.: PCT/US12/70395

§ 371 Date: Dec. 20, 2013

(30) Foreign Application Priority Data
Dec. 19, 2011 (IN) 3862/DEL/2011

(51) Int. Cl. G06T 1/20

(52) U.S. Cl. CPC G06T 1/20
USPC 345/522

(57) ABSTRACT

Programmable predication logic in command streamer instruction execution is described. In one example, the invention includes a method that includes receiving batch buffer execution start command at a command streamer, the batch buffer containing executable instructions, determining whether predication has been enabled for the instructions using the start command, if predication has been enabled, then comparing a predication condition to values stored in a predication register, and if the condition is satisfied by the predication register values, then executing the batch buffer.

### BACKGROUND

Computing techniques been developed to allow general purpose operations to be performed in a GPU (graphics processing unit). A GPU has a large number of simple parallel processing pipelines that are optimized for graphics processing. By moving general purpose operations that require many similar or identical parallel calculations to the GPU, these operations can be performed more quickly than on the CPU (Central Processing Unit) while processing demands on the CPU are reduced. This can reduce power consumption while improving performance.

However, the command buffers and command streamers of GPUs are not designed to optimize the transfer of intermediate values and commands between the CPU and GPU. GPUs frequently use separate memory storage and cache resources that are isolated from the CPU. GPUs are also optimized for sending final results to frame buffers for rendering images rather than being sent back a CPU for further processing.

Intel® 3D (Three-Dimensional) or GPGPU (General Purpose Graphics Processing Unit) driver software dispatches workloads to GPU (Graphics Processing Unit) hardware in a quantum of a command buffer by programming a MI_BATCH_BUFFER_START command in a ring buffer. In certain usage models, the driver processes the statistics outputted by the command buffer to evaluate the condition of the command buffers and then the driver determines whether to dispatch or skip the subsequent depended command buffers. This driver determination creates a latency degrading the performance of the commands because of the transfer of control from hardware of the command streamer and arithmetic logic unit to software of the driver and back to hardware again.

The GPGPU driver waits for the previously dispatched command buffer execution to be completed before it evaluates the condition out of the statistics output by the completed command buffer. Based on the evaluated condition, the driver decides if the subsequent dependent command buffer is to be executed or skipped.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a process flow diagram of executing a batch buffer using a predication enable bit according to an embodiment of the invention.

FIG. 2 is a process flow diagram of refreshing values in a predicate register according to an embodiment of the invention.

FIG. 3 is a hardware logic diagram of an arithmetic logic unit with a predication enable bit register according to an embodiment of the invention.

FIG. 4 is a block diagram of a portion graphics processing unit suitable for use with an embodiment of the invention.

FIG. 5 is a block diagram of a computer system suitable for use with an embodiment of the invention.

### DETAILED DESCRIPTION

Embodiments of the present invention provide a mechanism in GPU hardware, such as a command streamer to evaluate the conditions of predicate registers, such as command buffers, and skip the subsequent depended command buffers without software intervention. The mechanism can evaluate predicates on the fly avoiding a transfer of control from hardware to software. A generalized and programmable hardware component provides assistance to the software in providing self modifying command stream execution.

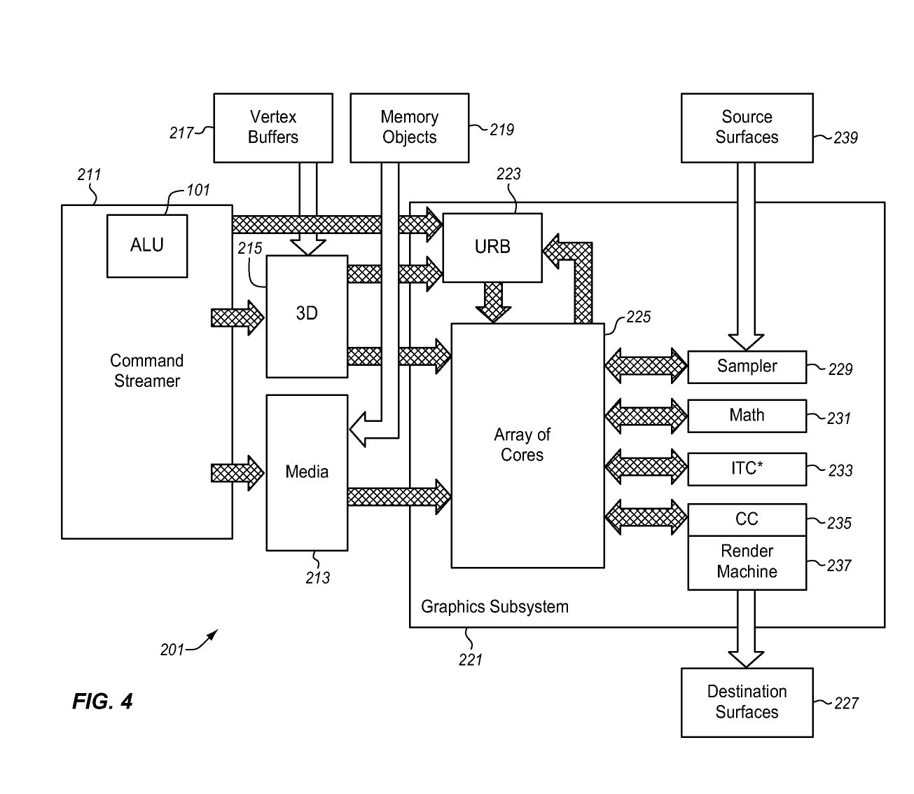

In one example, a “Predication Enable” control field is provided in a command executed before the start of the execution of a command sequence, such as a sequence loaded into a batch buffer. In the described example, this is referred to as a “MI_BATCH_BUFFER_START” command, where MI refers to memory interface. The control field, such as a flag, when parsed by a command streamer, indicates that the MI_BATCH_{—} BUFFER_START command should be skipped based on a value in a predicate register. In the described example, this is referred to as a “PR_RESULT_{—}1” register. In the described embodiment, there is also a “PR_RESULT_{—}0” register that is used to predicate a 3DPRIMITIVE command. This command is used to trigger rendering in a 3D engine 216 of the GPU 201 shown in FIG. 4. The invention is not limited to the particular names of commands and registers provided herein.

Command buffers, such as a particular MI_BATCH_BUFFER_START command can be skipped conditionally depending upon a predicate register value, such as the PR_RESULT_{—}1 value. A predication control field, such as a PREDICATION ENABLE field in the MI_BATCH_BUFFER_START command indicates whether the hardware is to use predication to determine whether to skip the command. When predication is enabled, then the hardware is to either skip or not skip the batch buffer depending on the PR_RESULT_{—}1 value. When predication is not enabled, then the command is executed without reference to the predication register.

The PR_RESULT_{—}1 value can be produced in any of a variety of different ways. In one example, it is the output of an MMIO (Memory-Mapped Input/Output) register. This MMIO register can be exercised just as any other GPU register. Any expression consisting of logical and arithmetic functions can be evaluated with the help of appropriate commands, such as an MI_MATH command, in the command streamer and the result can be subsequently moved to the PR_RESULT_{—}1 value. The MI_MATH command can be retrieved from a ring buffer or a command buffer to provide an ability to execute any logical or arithmetic expression. The logical and arithmetic expression can be executed using hardware logic in the command streamer based on ALU instructions delivered as payload in the MI_MATH command.

The embodiments described herein are described in the context of several specific commands and registers. These commands and registers are taken from the particular context of Intel® GPGPU, however, different commands and registers may be used instead of those named herein. These different commands and registers may be taken from GPGPU or from another context for executing commands through a command streamer and an arithmetic logic unit.

Start command:

The MI_BATCH_BUFFER_START command is used to initiate the execution of commands stored in a batch buffer. The command indicates the batch buffer at which execution is to start and provides values for the needed state registers including memory state selections. It can be executed directly from a ring buffer. The execution can be stopped either with an end command or with a new start command that points to a different batch buffer. In GPGPU contexts, this command can be an existing command.

Predication:

A new PREDICATION ENABLE control field can be added to the MI_BATCH_BUFFER_START command or a similar command. The MI_BATCH_BUFFER_START command has a pointer to the command buffer in memory which needs to be fetched and executed. This buffer will indicate the condition to apply to the predication register. If the PR_RESULT_{—}1 value is not set, then the command streamer, on parsing the MI_BATCH_BUFFER_START command with the Predication Enable Field set, skips the command. In other words, it does not execute the command in the buffer pointed to by MI_BATCH_BUFFER_START command. If the PR_RESULT_{—}1 value is set, then the command streamer executes the command resulting in execution of the command in the buffer that the MI_BATCH_BUFFER_START command points to.

Software can be used to program all of the command buffers and all of the dependent command buffers in the ring buffer as a single dispatch. The predication enable field can be set for the command buffers that need to be predicated in this same dispatch. This can easily be done by including the predication enable field in the command to which the field applies. However, predication can also be enabled in other ways. Software computes the PR_RESULT_{—}1 value by programming an MI_MATH command in the ring buffer before using the PR_RESULT_{—}1 register for predication of the subsequent command buffers. Software can then reprogram the MI_MATH command whenever the PR_RESULT_{—}1 value has to be recomputed.

Math Command:

A math command can be used to carry ALU (Arithmetic Logic Unit) instructions as a payload to be executed on an ALU. A graphics command streamer, on parsing the math command, outputs a new set of ALU instructions to the ALU block on every clock. If the ALU takes a single clock to process any given ALU instruction, then one instruction can be provided with each clock. Software can load the appropriate general purpose registers (GPRs) with appropriate values before programming the command streamer with the math command.

In the described example, the math command is referred to as an MI_MATH command. However any similar command can be used instead. The MI_MATH command allows software to send instructions to an ALU in a render command streamer. The MI_MATH command is a means by which the ALU can be accessed by the CPU to perform general purpose operations, that is operations that are not a part of graphics rendering. The MI_MATH command contains headers and a payload. The instructions for the ALU can form the data payload.

In some embodiments of the invention, ALU instructions are all a dword (double word) in size. The MI_MATH dword length can be programmed based on the number of ALU instructions packed into the payload so that the maximum number of instructions is limited by the maximum dword length supported. When the MI_MATH command is parsed by a command streamer, the command streamer outputs the payload dwords (ALU instructions) to the ALU.

The MI_MATH command, along with register and memory modifying commands in the command streamer, provide a powerful construct for 3D and GPGPU drivers in building self modifying command buffers (computing/storing thread/vertex counts, etc.). There are many applications for self modifying command buffers. This combination also provides an ability for software to carry generic computations in the front end of the 3D or GPGPU pipe without having back and forth transfers between the GPU and the CPU for the same command stream.

Table 1 shows example parameters for the MI_MATH command. This command or a similar command can be used to load up the batch buffer of the ALU with instructions. The package of instructions may take several clock cycles to complete even with parallel processing.

TABLE 1
MI_MATH

| | | |
|---|---|---|
| Project: | All | Length |
| Engine: | Render | Bias 16 |

The MI_MATH command allows SW to send instructions
to ALU in Render Command Streamer. MI_MATH command
is means by which ALU can be accessed. ALU
instructions form the data payload of MI_MATH
command, ALU instruction is dword in size. MI_MATH
Dword Length should be programmed based on the
number of ALU instructions packed, the max number
is limited by the max Dword Length supported.
When the MI_MATH command is parsed by the command
streamer it outputs the payload dwords (ALU
instructions) to the ALU. The ALU takes a single
clock to process any given instruction.

| Dword | Bit | Description | | |
|---|---|---|---|---|
| 0 | 31:29 | Command Type | | |
| | | Default Value: 0h | MI_COMMAND | Format: OpCode |
| | 28:23 | MI Command Opcode | | |
| | | Default Value: 1Ah | MI_MATH | Format: OpCode |
| | 22:8 | Reserved Project: | All | Format: MBZ |
| | | DWord Length | | |
| | 7:0 | Default Value: 0h | Excludes Dword (0, 1) | |
| | | Format: = n | | Total Length −2 |
| 1 | 31:0 | ALU Instruction 1 | | |
| | | Project: All | | |
| | | Format: Table Entry | | |
| | | This Dword is the | | |
| | | ????????? | | |
| 2 | 31:0 | ALU Instruction 2 | | |
| | | Project: All | | |
| | | Format: Table Entry | | |
| | | This Dword is the | | |
| | | ????????? | | |
| . . . | | . . . | | |
| . . . n | 31:0 | ALU Instruction n | | |
| | | Project: All | | |
| | | Format: Table Entry | | |
| | | This Dword is the | | |
| | | ????????? | | |

Programming Sequence

The operations described above can be represented as a programming sequence or a flow chart as described below. In the example of the programming sequence below, the commands described above are used and these are commented in this example.

MI_BATCH_BUFFER_START / / Executing of first command buffer,

| | |
|---|---|
| whose outputs are | / / evaluated to skip the next |

dependent command buffers
MI_LOAD_REGISTER_MEM / / Load the data in to GPR from
memory
.
.
.
MI_MATH / / Issue ALU instructions to process the data available
in GPR
MI_LOAD_REGISTER_REG / / Move the evaluated output from GPR
to

/ / PR_RESULT_1

MI_BATCH_BUFFER_START (predication enable is set for all
dependent command buffers)

/ / Based on the value in PR_RESULT_1
/ /batch buffer is predicated

MI_BATCH_BUFFER_START (Predication Enable Reset)

/ / This batch buffer is executed unconditionally

irrespective of

/ / PR_RESULT_1

Flow Sequence

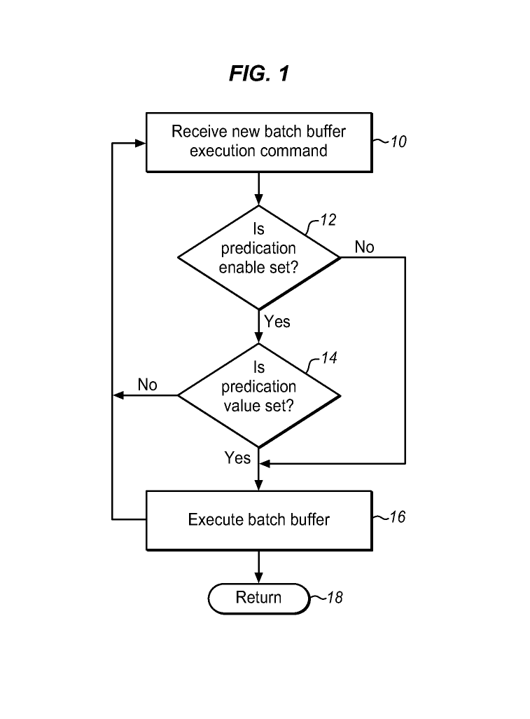

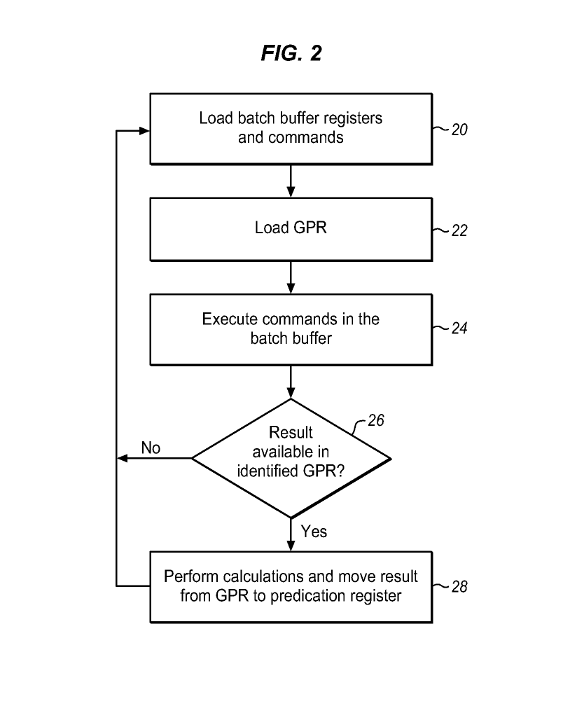

The operations of the programming sequence above can be represented as flow charts as shown in the process flow diagrams of FIGS. 1 and 2. FIG. 1 represents operations seen from the perspective of the command streamer. In FIG. 1, the process flow begins at block 10 by receiving a new batch buffer execution command at the command streamer. In the examples above, this command may be the MI_BATCH_BUFFER_START command. However the particular command and its attributes may be adapted to suit different applications. At block 12, the command streamer determines whether predication is enabled. This may be done by parsing the command and reading a field in the command or it may be done by decoding some aspect of the command. Alternatively, a flag may be set or provided in some other way. A field in the command may be a simple 0 or 1 to indicate that predication is either enabled or not enabled or it may be a more complex bit sequence that includes variations on different types of predication.

If predication is not enabled, then the process skips to block 16 to execute the batch buffer. After the execution, the process returns to receive a new batch buffer command. On the other hand, if predication is enabled, then the process checks the predication condition at block 14. In one example, the predication condition is a set/not set condition. If the value in the predication register is set, then the command is executed, if the value is not set, then the command is not executed. In another embodiment, the predication condition requires that an operation be performed against the predication register such as a greater than, less than, equal to, etc. If the condition is met, then the command is executed. If the condition is not met, then the command is not executed.

In the context of FIG. 1, if the condition is executed, then the process flows to block 16 to execute the condition. The process then returns 16 to block 10 to receive a new batch buffer execution command. The current batch buffer may be flushed to configure the command stream for the new command. If the condition is not executed, then the process flow goes directly to block 10 to receive a new command without executing the previous command.

The process flow of FIG. 1 provides control using both the predication enable field and using the predication register. This allows more flexibility in controlling the predication operations.

FIG. 2 shows a process flow diagram of refreshing values in the predicate register. At block 20, the batch buffer registers and commands are loaded. At block 22, the general purpose registers are loaded. At block 24, the commands that were loaded into the batch buffer are executed. This provides results that may be stored into any other registers for the next batch buffer operation.

At block 26, it is determined whether the results of the command execution are available in a general purpose register. This register may be identified, for example, in the MI_MATH command mentioned above, another execution command or in the start command. If the results are not available, then the process ends and returns to load new values into buffer registers. If the results are available, then the available results are loaded into the predicate register at block 28. The process then returns to load the buffer with the new batch of register values at block 20.

The operations of FIG. 2 allow the predication register to be updated with each batch processing. The particular values to be stored in the predication register can be determined by the commands. This allows operations to be performed specifically to determine values for the predication register due to the flexibility in designating a GPR for use with the predication register. As a result a general purpose register is determined or specified using a command from the batch buffer. This allows a single or small number of general purpose registers to be used in determining whether the results are available in a general purpose register. If the register is available then the values the predication register can be updated with a particular value from the specified register. Similarly, these specified registers are written based on the command.

Arithmetic Logic Unit:

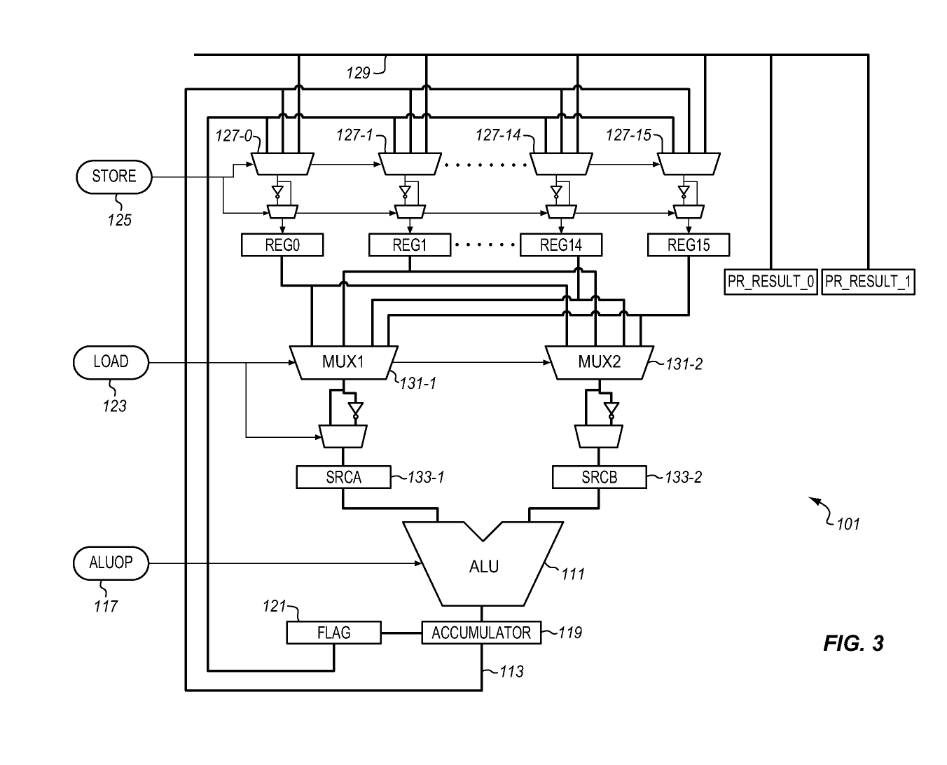

Referring to FIG. 3, in some embodiments of the invention, an ALU (Arithmetic Logic

Unit) 111 in a graphics hardware command streamer 101 is used. The ALU can be exercised by software using, for example, the MI_MATH command described above. The output 113 of the ALU can be stored in any MMIO register which can be read from or written to by hardware or software, such as REG0 to REG15. After executing the MI_MATH command, the contents of any MMIO register can be moved to any other MMIO register or to a location in GPU memory (not shown).

The ALU (arithmetic and logic unit) supports arithmetic (addition and subtraction) and logical operations (AND, OR, XOR) on two 64 bit operands. The ALU has two 64-bit registers at source input A (SRCA) and source input B (SRCB) to which the operands should be loaded. The ALU performs operations on the contents of the SRCA and SRCB registers based on the ALU instructions supplied at 117 and the output is sent to a 64-bit Accumulator 119. A zero flag and a carry flag 121 reflect the accumulator status to each register. The command streamer 101 implements sixteen 64-bit general purpose registers REG0 to REG15 which are MMIO mapped. These registers can be accessed similar to any other GPU MMIO mapped register. Any selected GPR register can be moved to the SRCA or SRCB register using a “LOAD” instruction 123. Outputs of the ALU (Accumulator, ZF and CF) can be moved to any of the GPRs using a “STORE” instruction 125. Any of the GPRs can be moved to any of the other GPU registers using existing techniques, for example, an MI_LOAD_REGISTER_REG GPU instruction. GPR values can be moved to any memory location using existing techniques, for example, an MI_LOAD_REGISTER_MEM command. This gives complete flexibility for the use of the output of the ALU.

Table 2 shows an example set of commands that can be programmed into the ALU using, for example, the MI_MATH command. In Table 2, the operation code, bits 20-31, indicates the operation or function to be performed, while the operands, bits 0-19, are the operands upon which the operation code operates. The commands use 32 bits as identified in Table 2.

TABLE 2

| 31-20 | 19-10 | 9-0 |
|---|---|---|
| Opcode | Operand1 | Operand2 |
| LOAD | SRCA/SRCB | REG0 . . . REG15 |
| LOADINV | SRCA/SRCB | REG0 . . . REG15 |
| LOAD0 | SRCA/SRCB | N/A |
| LOAD1 | SRCA/SRCB | N/A |
| ADD | N/A | N/A |
| SUB | N/A | N/A |
| AND | N/A | N/A |
| OR | N/A | N/A |
| XOR | N/A | N/A |
| NOOP | N/A | N/A |
| STORE | REG0 . . . REG15 | ACCU/CF/ZF |
| STOREINV | REG0 . . . REG15 | ACCU/CF/ZF |

Referring further to FIG. 3 each of the 16 registers, REG0 to REG15, is fed by a respective one of 16 multiplexers 127-0 to 127-15. Each multiplexer can accept at least three different inputs. As shown in FIG. 3, a first input 129 is a generalized MMIO interface for register reads and writes. The second input 113 comes from the accumulator 119 of the ALU and the third input 121 is the flag for the ALU. The store command 125 can be applied to each of the multiplexers 127 to command any of the various inputs to be applied to the respective general purpose register (GPR). In addition, the generic MMIO interface is coupled to a PR_RESULT_{—}0 and a PR_RESULT_{—}1 register. The PR_RESULT_{—}0 register enables a 3D rendering section, while the PR_RESULT_{—}1 register is used for predication.

Each of the registers can be connected to either of two multiplexers (muxes) 131-1 131-2. The multiplexers determine which values are applied to the source registers 133-1 133-2 which supply the values SRCA and SRCB, as described above. The load command 123 is applied to these two muxes to load values into the SRCA and the SRCB registers. Using this architecture any of the values in any of the general purpose registers can be applied as the inputs to the ALU 111. As each clock pulse is applied, different combinations of store, load, and ALU operations can be applied to the system to create different arithmetic and logical functions.

The ALU architecture of FIG. 3 is shown as an example. More or fewer parallel streams may be used More or fewer stages of registers and muxes may be used. More or fewer commands may be used and the names of the various commands, muxes, and registers may be changed to suit different implementations.

FIG. 4 is a generalized hardware diagram of a graphics processing unit suitable for use with the present invention. The GPU 201 includes a command streamer 211 which contains the ALU 101 of FIG. 3. Data from the command streamer is applied to a media pipeline 213. The command streamer is also coupled to a 3D fixed function pipeline 215. The command streamer manages the use of the 3D and media pipelines by switching between the pipelines and forwarding command streams to the pipeline that is active. The 3D pipeline provides specialized primitive processing functions while the media pipeline performs more general functionality. For 3D rendering, the 3D pipeline is fed by vertex buffers 217 while the media pipeline is fed by a separate group of memory objects 219. Intermediate results from the 3D and media pipelines as well as commands from the command streamer are fed to a graphics subsystem 221 which is directly coupled to the pipelines and the command streamer.

The graphic subsystem 221 contains a unified return buffer 223 coupled to an array of graphics processing cores 225. The unified return buffer contains memory that is that is shared by various functions to allow threads to return data that later will be consumed by other functions or threads. The array of cores 225 process the values from the pipeline streamers to eventually produce destination surfaces. 227 The array of cores has access to sampler functions 229, math functions 231, inter-thread communications 233, color calculators 235, and a render cache 237 to cache finally rendered surfaces. A set of source surfaces 239 is applied to the graphics subsystem 221 and after all of these functions 229, 231, 235, 237, 239 are applied by the array of cores, a set of destination surfaces 227 is produced. For purposes of general purpose calculations, the command streamer 211 and ALU are used to run operations to only the ALU or also through the array of cores 225, depending on the particular implementation.

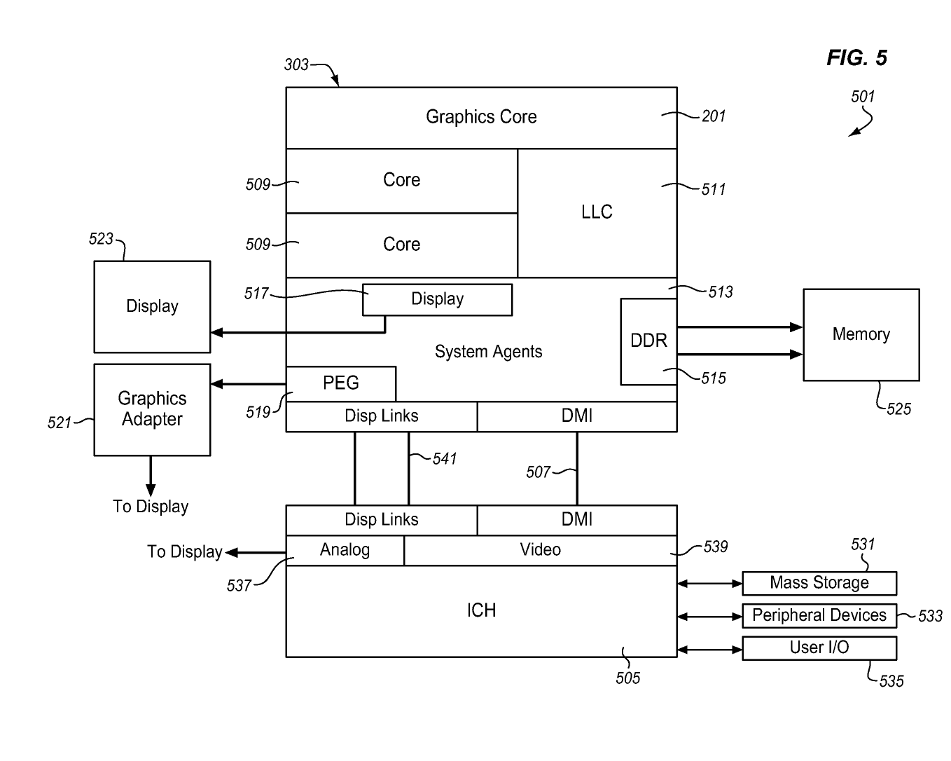

Referring to FIG. 5, the graphics core 201 is shown as part of a larger computer system 501. The computer system has a CPU 503 coupled to an input/output controller hub (ICH) 505 through a DMI (Direct Media Interface) 507. The CPU has one or more cores for general purpose computing 509 coupled to the graphics core 201 and which share a Last Level Cache 511. The CPU includes system agents 513 such as a memory interface 515, a display interface 517, and a PCIe interface 519. In the illustrated example, the PCIe interface is for PCI express graphics and can be coupled to a graphics adapter 521 which can be coupled to a display (not shown). A second or alternative display 523 can be coupled to the display module of the system agent. This display will be driven by the graphics core 201. The memory interface 515 is coupled to system memory 525.

The input/output controller hub 505 includes connections to mass storage 531, external peripheral devices 533, and user input/output devices 535, such as a keyboard and mouse. The input/output controller hub may also include a display interface 537 and other additional interfaces. The display interface 537 is within a video processing subsystem 539. The subsystem may optionally be coupled through a display link 541 to the graphics core of the CPU.

A wide range of additional and alternative devices may be coupled to the computer system 501 shown in FIG. 5. Alternatively, the embodiments of the present invention may be adapted to different architectures and systems than those shown. Additional components may be incorporated into the existing units shown and more or fewer hardware components may be used to provide the functions described. One or more of the described functions may be deleted from the complete system.

Embodiments of the present invention provide a mechanism in a command streamer to skip any command buffer depending on value set in a register. In the described example, this is the predicate enable bit set in a PR_RESULT_{—}1 register, however, the invention is not so limited. This provides a hardware mechanism in a command streamer, a hardware structure, to perform arithmetic and logical operations by means of a command, here the MI_MATH command, programmed in the command buffer or ring buffer. The output of the computed expression can be stored to any MMIO register. This enables a driver to evaluate any arbitrary condition involving arithmetic and logical expressions in hardware on the fly by programming MI_MATH appropriately in the command buffer or ring buffer. The evaluated output of the computed result may be moved to the PR_RESULT_{—}1 register. If a predicate enable bit is set, then the evaluated output may be used to predicate the subsequent command buffers.

3D and GPGPU drivers may use embodiments of the present invention to accelerate the rate at which command buffers can be dispatched to a GPU by avoiding the long bubbles in hardware between consecutive dispatches. Avoiding these delays results in a performance boost. In addition, running a 3D or GPU driver, can save CPU power because of improved use of the CPU.

A wide range of additional and alternative devices may be coupled to the computer system 501 shown in FIG. 5. Alternatively, the embodiments of the present invention may be adapted to different architectures and systems than those shown. Additional components may be incorporated into the existing units shown and more or fewer hardware components may be used to provide the functions described. One or more of the described functions may be deleted from the complete system.

It is to be appreciated that a lesser or more equipped system than the examples described above may be preferred for certain implementations. Therefore, the configuration of the exemplary systems and circuits may vary from implementation to implementation depending upon numerous factors, such as price constraints, performance requirements, technological improvements, or other circumstances.

Embodiments may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown;

nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method comprising:
receiving batch buffer execution start command at a command streamer, the batch buffer containing executable instructions;
determining whether predication has been enabled for the instructions using the start command;
if predication has been enabled, then comparing a predication condition to values stored in a predication register;
if the condition is satisfied by the predication register values, then executing the batch buffer.

2. The method of claim 1, further comprising if predication has not been enabled, then executing the batch buffer.

3. The method of claim 1, further comprising if predication is enabled and the condition is not satisfied by the predication register values, then not executing the batch buffer.

4. The method of claim 3, further comprising receiving a second batch buffer execution start command at the command streamer.

5. The method of claim 1, further comprising writing data from a designated general purpose register to the predication register before comparing.

6. The method of claim 5, further comprising, before comparing a predication condition, writing values from a general purpose register to the predication register.

7. The method of claim 6, wherein writing values is performed during execution of a previous batch buffer.

8. The method of claim 1, wherein determining whether predication is enabled comprises reading a field of the batch buffer execution start command.

9. An apparatus comprising:
a batch buffer to contain executable instructions;
a command streamer to receive a batch buffer execution start command; and
a predication enable register to store a value indicating whether predication is enabled or not enabled,
wherein the command streamer compares a predication condition to the value stored in the predication register and, if the condition is satisfied by the predication register value, then the command streamer executes the batch buffer.

10. The apparatus of claim 9, if predication has not been enabled, then the command streamer executing the batch buffer notwithstanding the value stored in the predication enable register.

11. The apparatus of claim 9, further comprising a plurality of general purpose registers and wherein the command streamer writes data from at least one general purpose register to the predication enable register before comparing.

12. The apparatus of claim 9, wherein the batch buffer execution command includes a field, the field designating whether predication is enabled and wherein the command streamer reads the field to determine whether predication has been enabled.

13. The apparatus of claim 9, further comprising a media pipeline coupled to the command streamer to execute command streams using a group of memory objects.

14. The apparatus of claim 9, further comprising an arithmetic logic unit coupled to the batch buffer to receive commands and stored memory values from the batch buffer and execute operations in response to the commands.

15. The apparatus of claim 14, wherein the arithmetic logic unit is coupled to the command streamer to receive command words in payload of a command from the command streamer, the arithmetic logic unit comprising multiplexers to receive the command words and configure the arithmetic logic unit to respond to the commands.

16. A method comprising:
loading batch buffer registers of a command streamer;
loading commands into the batch buffer;
executing commands in an arithmetic logic unit of the command streamer;
refreshing values of general purpose registers based on the command execution;
updating a predication register based on the refreshed values of the general purpose registers;
updating the batch buffer registers; and
applying the updated predication register to a condition as a condition of executing the updated batch buffer registers.

17. The method of claim 16, further comprising determining whether results of executing commands in an arithmetic logic unit are available in the general purpose registers and wherein updating a predication register comprises updating the predication register only if the results are available.

18. The method of claim 17, wherein determining whether the results are available comprising identifying a general purpose register using a command from the batch buffer and determining whether the identified register is available.

19. The method of claim 16, wherein refreshing values comprises writing specified data to a specified general purpose register based on a command of the executed commands and wherein determining whether the results are available comprises determining whether results are available in the specified general purpose register.

20. The method of claim 16, further comprising determining whether predication is enabled based on a command of the batch buffer and wherein applying the updated predication register as a condition comprises applying only if predication is enabled.
